(19) United States
(12) Patent Application Publication
(10) Pub. No.: US 2025/0271565 A1
(43) Pub. Date: Aug. 28, 2025

(54) OBJECT DETECTION APPARATUS

(71) Applicant: DENSO CORPORATION, Kariya-city (JP)

(72) Inventors: Yu KOYAMA, Nisshin-city (JP); Hiroshi SUZUKI, Kariya-city (JP); Tetsuya AOYAMA, Kariya-city (JP); Takuya NOMURA, Kariya-city (JP)

(21) Appl. No.: 19/205,171

(22) Filed: May 12, 2025

Related U.S. Application Data
(63) Continuation of application No. PCT/JP2023/037548, filed on Oct. 17, 2023.

(30) Foreign Application Priority Data
Nov. 14, 2022 (JP) 2022-182137

(51) Int. Cl. G01S 7/536; G01S 7/52; G01S 15/04; G01S 15/34; G01S 15/931

(52) U.S. Cl. CPC G01S 7/536; G01S 7/52077; G01S 15/04; G01S 15/34; G01S 15/931

(57) ABSTRACT

An object detection apparatus includes a transmission signal generator, a correlation signal generator, and a signal determiner. The transmission signal generator can generate a plurality of types of transmission signals changing frequencies thereof over time, and outputs one of the plurality of types of transmission signals to a transmitter transmitting a probe wave having a frequency thereof modulated based on a frequency change mode of the transmission signal. The correlation signal generator generates a correlation signal indicating a correlation between a reference signal and a reception signal. A plurality of correlation signal generators are provided in correspondence with the plurality of types of transmission signals. The signal determiner performs a signal determination of determining, based on the correlation signal, whether a received wave has a frequency change mode corresponding to a frequency modulation mode of the probe wave, and performs the signal determination by comparing a plurality of correlation signals.

### CROSS-REFERENCE TO RELATED APPLICATION

The present application is a continuation application of International Application No. PCT/JP2023/037548, filed on Oct. 17, 2023, which claims priority to Japanese Patent Application No. 2022-182137, filed on Nov. 14, 2022. The contents of these applications are incorporated herein by reference in their entirety.

### BACKGROUND

### Technical Field

The present disclosure relates to an object detection apparatus.

### Background Art

An object detection apparatus described in the prior art includes a wave transmitter, a wave receiver, a frequency coincidence degree calculator, an amplitude peak detector, and a distance determiner. The wave transmitter transmits, as probe waves, ultrasonic waves changing in frequency thereof in a prescribed pattern with the lapse of time. The wave receiver receives ultrasonic waves. The frequency coincidence degree calculator calculates the degree of coincidence between the frequency of received waves and the prescribed pattern. The amplitude peak detector detects an amplitude peak of the received waves. Specifically, for example, the amplitude peak detector detects an amplitude peak of the received waves by comparing the inclination of amplitude of the received waves with a prescribed threshold of inclination. The distance determiner determines the distance to an object based on the degree of coincidence calculated by the frequency coincidence degree calculator, and the detection result of the amplitude peak obtained by the amplitude peak detector.

### SUMMARY

In the present disclosure, provided is an object detection apparatus as the following.

The object detection apparatus includes: a transmission signal generator capable of generating a plurality of types of transmission signals changing frequencies thereof over time, and configured to output a transmission signal to a transmitter, the transmission signal being one of the plurality of types of transmission signals, and the transmitter being configured to transmit a probe wave that is an ultrasonic wave having a frequency thereof modulated based on a frequency change mode of the transmission signal; a correlation signal generator configured to generate a correlation signal indicating a correlation between a reference signal and a reception signal; and a signal determiner configured to perform a signal determination of determining, based on the correlation signal, whether the received wave has a frequency change mode corresponding to a frequency modulation mode of the probe wave, wherein a plurality of the correlation signal generators are provided in correspondence with the plurality of types of transmission signals, and the signal determiner is configured to perform the signal determination by comparing a plurality of the correlation signals.

### BRIEF DESCRIPTION OF THE DRAWINGS

FIG. 1 is a block diagram illustrating a schematic functional configuration of an object detection apparatus according to a first embodiment of the present disclosure.

FIG. 2A is a graph illustrating one example of transmission signals output from a transmission signal generator illustrated in FIG. 1.

FIG. 2B is a graph illustrating another example of the transmission signals output from the transmission signal generator illustrated in FIG. 1.

FIG. 2C is a graph illustrating another example of the transmission signals output from the transmission signal generator illustrated in FIG. 1.

FIG. 3 is a graph illustrating one example of reference signals used in correlation signal generators illustrated in FIG. 1.

FIG. 4 is time charts illustrating one example of a code determination performed by a signal determiner illustrated in FIG. 1.

FIG. 5 is a flowchart illustrating one example of the code determination performed by the signal determiner illustrated in FIG. 1.

FIG. 6A is a time chart that, together with FIG. 6B, illustrates a different example of a method of determining a code determination range illustrated in FIG. 4.

FIG. 6B is a time chart that, together with FIG. 6A, illustrates the different example of the method of determining a code determination range illustrated in FIG. 4.

FIG. 7 is a time chart that illustrates another different example of the method of determining a code determination range illustrated in FIG. 4.

FIG. 8A is a time chart that illustrates another different example of the method, illustrated in FIG. 4, of determining a code determination range.

FIG. 8B is a time chart that illustrates another different example of the method of determining a code determination range illustrated in FIG. 4.

FIG. 8C is a time chart that illustrates another different example of the method of determining a code determination range illustrated in FIG. 4.

FIG. 9 is time charts illustrating a different example of a code determination method performed by the signal determiner illustrated in FIG. 1.

FIG. 10 is a flowchart illustrating a different example of the code determination method performed by the signal determiner illustrated in FIG. 1.

FIG. 11 is a block diagram illustrating a schematic functional configuration of an object detection apparatus according to a second embodiment of the present disclosure.

FIG. 12 is a block diagram illustrating a schematic functional configuration of an object detection apparatus according to a third embodiment of the present disclosure.

FIG. 13 is time charts illustrating one example of a code determination method performed by a signal determiner illustrated in FIG. 12.

FIG. 14 is a flowchart illustrating one example of the code determination method performed by the signal determiner illustrated in FIG. 12.

FIG. 15 is time charts illustrating a different example of the code determination method performed by the signal determiner illustrated in FIG. 12.

FIG. 16 is a flowchart illustrating a different example of the code determination method performed by the signal determiner illustrated in FIG. 12.

### DETAILED DESCRIPTION OF THE PREFERRED EMBODIMENTS

In Patent Literature 1, a frequency pattern included in probe waves appears in reflected waves when the reflected waves have a certain large size of amplitude. Accordingly, the object detection apparatus described in Patent Literature 1 can improve the accuracy of detecting an object, by determining the distance to the object based on the degree of coincidence of frequency and the detection result of the amplitude peak.

[PTL 1] JP 7000981 B

This type of object detection apparatus is required to improve as much as possible the accuracy of code determination, i.e., the accuracy of determining whether the received wave of this time is a reflected wave formed when the probe wave, which has been transmitted by the own apparatus, is reflected by an object. The present disclosure has been made in view of the circumstances and the like described above. That is, the present disclosure provides, for example, an object detection apparatus having much more improved accuracy of code determination.

According to one aspect of the present disclosure, an object detection apparatus includes:
a transmission signal generator capable of generating a plurality of types of transmission signals changing frequencies thereof over time, and configured to output a transmission signal to a transmitter, the transmission signal being one of the plurality of types of transmission signals, and the transmitter being configured to transmit a probe wave that is an ultrasonic wave having a frequency thereof modulated based on a frequency change mode of the transmission signal;
a correlation signal generator configured to generate a correlation signal indicating a correlation between a reference signal corresponding to the transmission signal and a reception signal corresponding to a received wave, the received wave being an ultrasonic wave received by a receiver, and the reception signal being output by the receiver; and
a signal determiner configured to perform a signal determination of determining, based on the correlation signal, whether the received wave has a frequency change mode corresponding to a frequency modulation mode of the probe wave, wherein
a plurality of the correlation signal generators are provided in correspondence with the plurality of types of transmission signals, and
the signal determiner is configured to perform the signal determination by comparing a plurality of the correlation signals.

In the sections of the application document, each of elements may sometimes have a parenthesized reference sign assigned thereto. However, such a reference sign only represents one example of a corresponding relationship between the element and specific means described later in the Embodiments. Accordingly, the present disclosure is not to be limited at all by the description of reference signs.

### Embodiments

Hereinafter, embodiments of the present disclosure will be described based on the drawings. Descriptions regarding various applicable modified examples of one embodiment may possibly prevent the understanding of the embodiment if inserted in the middle of a series of descriptions about the embodiment. Therefore, modified examples are collectively described after the descriptions of an embodiment.

### First Embodiment: Configuration

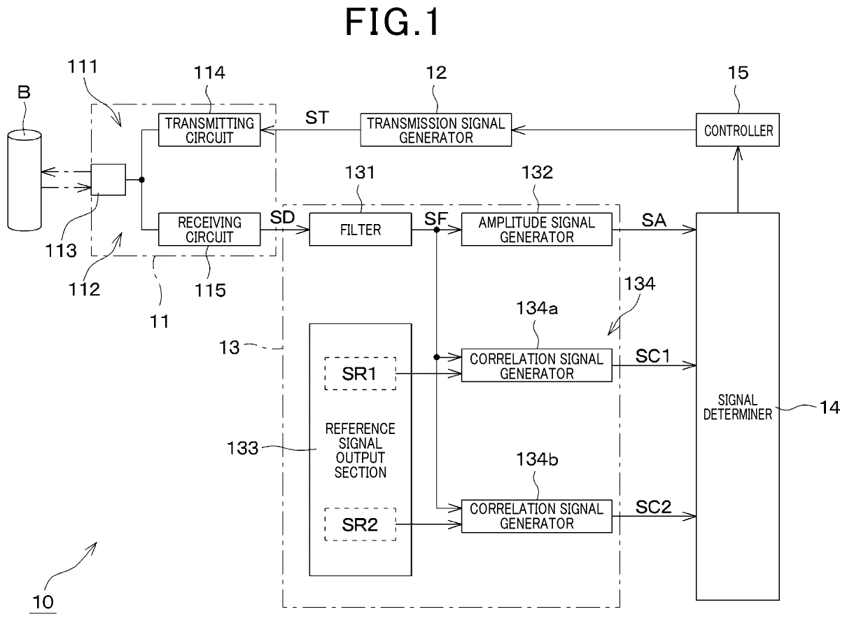

FIG. 1 illustrates a schematic configuration of an object detection apparatus 10 according to a first embodiment. With reference to FIG. 1, the object detection apparatus 10 is configured to be mounted on a mobile object such as a vehicle and thereby detect an object B present around the mobile object. Here, the object B as an object to be detected by the object detection apparatus 10 is a physical object that can be an impediment to movement of the mobile object having the object detection apparatus 10 mounted thereon, and can also be called an “obstacle”, a “candidate obstacle”, or a “target”. To “detect” an object B means detecting at least the presence of an object B, i.e., an obstacle, and can include, for example, measuring the distance to the object B, and determining the type of the object B (for example, a pedestrian, another vehicle, or a building) or the shape of the object B. For example, acquiring an effective measured value of the distance to the object B can indicate the presence of the object B corresponding to the measured value. Accordingly, for example, when the object detection apparatus 10 measures the distance to the object B and outputs the measured distance to an unillustrated external apparatus mounted to the own vehicle, and the output does not include information directly indicating the presence or absence of the object B, the object detection apparatus 10 can be an apparatus that “detects” the object B. The “information directly indicating the presence or absence” of the object B is, for example, a signal or data that represents “1” or “HI” for presence of the object B in a prescribed detection range, while representing “0” or “LO” for non-presence. The same applies to the determination of the type or the shape of the object B, and effective determination of these matters can indicate the presence of the object B corresponding to the determination result.

In the present embodiment, the mobile object is a vehicle, specifically a motor vehicle. A vehicle having the object detection apparatus 10 mounted thereon is hereinafter called an “own vehicle”. The object detection apparatus 10 is configured to transmit probe waves, which are ultrasonic waves, to an external space of the own vehicle, and receive received waves including reflected waves formed by the probe waves being reflected by an object B present in the external space, and thereby detect the object B by which the reflected waves have been reflected. The “received waves” can include noise or interference in addition to the reflected waves formed by the probe waves being reflected by the object B. The “interference” includes ultrasonic waves transmitted from another apparatus different from the object detection apparatus 10 mounted on the own vehicle, and are typically probe waves from the same type of apparatus mounted on another vehicle, or reflected waves formed by the probe waves being reflected by, for example, an exterior wall of a building. The object detection apparatus 10 includes a transceiver 11, a transmission signal generator 12, a reception signal processing section 13, a signal determiner 14, and a controller 15. Hereinafter, the configurations of the components in the object detection apparatus 10 will be described.

The transceiver 11 is a constituent element for transmitting probe waves and receiving received waves, and includes a transmitter 111 and a receiver 112. The transmitter 111 is provided so as to be capable of transmitting, to an external space of the own vehicle, probe waves as ultrasonic waves having the frequency thereof modulated in correspondence with a transmission signal ST input from the transmission signal generator 12. The receiver 112 is configured to receive received waves as ultrasonic waves and generate a reception signal SD corresponding to the reception state (i.e., the intensity, the frequency, or the like) of the received waves, and output the reception signal SD to the reception signal processing section 13. In the present embodiment, the transceiver 11 includes a so-called “transmission and reception integrated” configuration. That is, the transmitter 111 includes one transducer 113 having an ultrasonic wave transmitting function and an ultrasonic wave receiving function, and a transmitting circuit 114 electrically connected to the transducer 113. The receiver 112 includes the one transducer 113 shared with the transmitter 111, and a receiving circuit 115 electrically connected to the transducer 113. The transducer 113 has therein an electro-mechanical energy transformation device such as a piezoelectric device, and has a configuration of a so-called resonance-type ultrasonic microphone having a prescribed resonance frequency.

The transmitting circuit 114 is provided so as to drive the transducer 113 based on the transmission signal ST input, and thereby make the transducer 113 transmit probe waves with an ultrasonic band. Specifically, the transmitting circuit 114 has a circuit configuration of a digital/analog conversion circuit, a driver circuit, or the like for generating, based on the transmission signal ST, a drive signal for driving the transducer 113. That is, the transmitting circuit 114 is configured to perform processing such as digital/analog conversion on the transmission signal ST output from the transmission signal generator 12, and apply, to the transducer 113, a drive signal, i.e., a drive voltage, that is an AC voltage generated by the processing. The receiving circuit 115 is provided so as to generate a reception signal SD corresponding to the reception result of received waves in the transducer 113, and output the reception signal SD generated to the reception signal processing section 13. Specifically, the receiving circuit 115 has a circuit configuration of an amplifying circuit, an analog/digital conversion circuit, or the like for converting, to the reception signal SD, the voltage generated in the device, i.e., the AC voltage generated in the transducer 113 by the reception of a received wave. That is, the receiving circuit 115 is configured to perform signal processing, such as amplification and analog/digital conversion, on the voltage generated in the device, i.e., a voltage signal input from the transducer 113, and thereby generate a reception signal SD corresponding to the frequency and the amplitude of the received waves and output the reception signal SD.

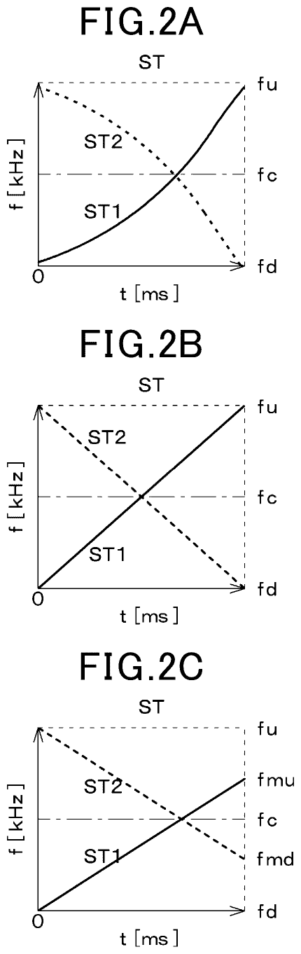

The transmission signal generator 12 is provided so as to generate a transmission signal ST changing in frequency thereof over time, and output the transmission signal ST to the transmitter 111. That is, the transmission signal generator 12 has a circuit configuration of a transmitter circuit or the like capable of generating an AC signal (for example, a pulse signal) of any frequency in a prescribed frequency range in which the frequency is variable. In the present embodiment, the transmission signal generator 12 is configured to be capable of generating a plurality of types of transmission signals ST having different frequency change modes, and output one of the plurality of types of transmission signals ST to the transmitter 111. Specifically, the transmission signal generator 12 is, as illustrated in FIG. 2A and the like, configured to be capable of generating and outputting an up transmission signal ST1 having a feature of increasing the frequency thereof, and a down transmission signal ST2 having a feature of decreasing the frequency thereof. In FIG. 2A and the like, the horizontal axis t represents time, and the vertical axis f represents frequency. One of the up transmission signal ST1 and the down transmission signal ST2 corresponds to a “first transmission signal”, and the other to a “second transmission signal”. That is, the transmission signals ST that the transmission signal generator 12 is capable of generating and outputting include the up transmission signal ST1 and the down transmission signal ST2. In the present embodiment, the transmission signal generator 12 is configured to selectively generate and output one of the up transmission signal ST1 or the down transmission signal ST2. Hereinafter, for simple description, the up transmission signal ST1 is defined as corresponding to the “first transmission signal”, and the down transmission signal ST2 to the “second transmission signal”. However, as described later, the present disclosure is obviously not to be limited to this aspect.

For example, as illustrated in FIG. 2A, the up transmission signal ST1 and the down transmission signal ST2 can be set as signals changing in frequencies thereof curvaceously and continuously. In this case, the frequency change modes of the up transmission signal ST1 and the down transmission signal ST2 are set to have a relationship of being inverted vertically in the drawing. That is, the increase mode of the up transmission signal ST1 in which the frequency thereof increases with the lapse of time is set to be coincident with the decrease mode of the down transmission signal ST2 in which the frequency thereof decreases with the lapse of time. Specifically, the up transmission signal ST1 is set such that the frequency thereof increases over time from a prescribed lower-limit frequency fd toward a prescribed upper-limit frequency fu, and that the increase of frequency is increased over time. On the other hand, the down transmission signal ST2 is set such that the frequency thereof decreases over time from the upper-limit frequency fu toward the lower-limit frequency fd, and that the decrease of frequency is increased over time. When the lapse of time from the start point, i.e., t=0, is the same, the inclination, i.e., the increase of frequency per unit time, of the up transmission signal ST1 is set to be identical to the inclination, i.e., the decrease of frequency per unit time, of the down transmission signal ST2. A center frequency fc illustrated in FIG. 2A is an intermediate value between the lower-limit frequency fd and the upper-limit frequency fu, i.e., an average value thereof, and is typically a resonance frequency. The waveform of the up transmission signal ST1 and the waveform of the down transmission signal ST2 are set to have an intersection at the center frequency fc.

Alternatively, for example, as illustrated in FIG. 2B, the up transmission signal ST1 and the down transmission signal ST2 can be set as so-called linear chirp signals changing in frequency thereof linearly. In this case, the up transmission signal ST1 is set such that the frequency thereof increases linearly over time from the lower-limit frequency fd toward the upper-limit frequency fu. On the other hand, the down transmission signal ST2 is set such that the frequency thereof decreases linearly over time from the upper-limit frequency fu toward the lower-limit frequency fd. The inclination, i.e., the increase of frequency per unit time, of the up transmission signal ST1 is set to have an identical absolute value to, but an opposite positive or negative sign from the inclination, i.e., the decrease of frequency per unit time, of the down transmission signal ST2. As described above, also in the example of FIG. 2B, the frequency change modes of the up transmission signal ST1 and the down transmission signal ST2 are, similarly to the example of FIG. 2A, set to have a relationship of being inverted vertically in the drawing. The waveform of the up transmission signal ST1 and the waveform of the down transmission signal ST2 are set to have an intersection at the center frequency fc.

Here, in the examples of the transmission signals ST illustrated in FIGS. 2A and 2B, the frequency band (i.e., fd to fu) of the up transmission signal ST1 is set to be coincident with the frequency band of the down transmission signal ST2. In contrast, for example, as illustrated in FIG. 2C, the up transmission signal ST1 and the down transmission signal ST2 can be set as so-called shift chirp signals. In this case, the up transmission signal ST1 and the down transmission signal ST2 are set such that parts of the frequency bands thereof overlap with each other, but the remaining parts do not. Specifically, in the example of FIG. 2C, the up transmission signal ST1 is set such that the frequency thereof increases linearly over time from the lower-limit frequency fd toward an upper intermediate frequency fmu. The upper intermediate frequency fmu is a frequency between the upper-limit frequency fu and the center frequency fc. On the other hand, the down transmission signal ST2 is set such that the frequency thereof decreases linearly over time from the upper-limit frequency fu toward a lower intermediate frequency fmd. The lower intermediate frequency fmd is a frequency between the lower-limit frequency fd and the center frequency fc. The upper intermediate frequency fmu and the lower intermediate frequency fmd can be set so that the intermediate value therebetween, i.e., the average value thereof is the center frequency fc. The overlapping part of the frequency bands is provided around the center frequency fc (i.e., fmd to fmu).

Referring back to FIG. 1, the reception signal processing section 13 is configured to perform various types of signal processing such as filtering on the reception signal SD output from the receiving circuit 115, and thereby generate an amplitude signal SA and a correlation signal and output the signals to the signal determiner 14. The reception signal processing section 13 has a configuration of a vehicle-mounted microcomputer including a CPU and the like exhibiting a prescribed function by executing a program, and/or of a hardware circuit configured to exhibit a prescribed processing function such as filtering. Specifically, the reception signal processing section 13 includes a filter 131, an amplitude signal generator 132, a reference signal output section 133, and a correlation signal generator 134.

The filter 131 is configured to filter the reception signal SD (for example, band-pass filtering), and output, to the amplitude signal generator 132 and the correlation signal generator 134, a filtered signal SF that is the reception signal SD having undergone the filtering. The amplitude signal generator 132 is provided so as to transform the filtered signal SF to an amplitude signal SA. The “amplitude signal SA” is a signal indicating the size of amplitude (for example, an envelope of amplitude) of the filtered signal SF, i.e., the reception signal SD that is an AC signal. Specifically, the amplitude signal generator 132 is configured to generate an amplitude signal SA based on the filtered signal SF, using a well-known method such as envelop detection, and output the amplitude signal SA to the signal determiner 14. In the cases of an IQ signal (i.e., a complex signal) having undergone quadrature detection, applying low-pass filtering can achieve the same effect as applying band-pass filtering to the original signal.

The reference signal output section 133 is provided so as to output, to the correlation signal generator 134, a reference signal used for correlation calculation performed in the correlation signal generator 134. The “correlation calculation” means calculating a correlation, i.e., similarity, between two signals, in other words, something corresponding to the “degree of coincidence” in Patent Literature 1, and a correlation signal, which is a calculation result, indicates higher correlation, i.e., similarity, as the value of the signal is greater. The reference signal is a criterial signal to be, for the correlation calculation, compared with the frequency properties of the reception signal SD, i.e., the filtered signal SF, and has frequency properties corresponding to the frequency properties of the transmission signal ST. That is, the reference signal output section 133 is configured to determine a reference signal to be output to the correlation signal generator 134, based on the transmission signal ST output from the transmission signal generator 12. Specifically, the reference signal output section 133 outputs a first reference signal SR1 corresponding to the up transmission signal ST1, i.e., the first transmission signal, and outputs a second reference signal SR2 corresponding to the down transmission signal ST2, i.e., the second transmission signal.

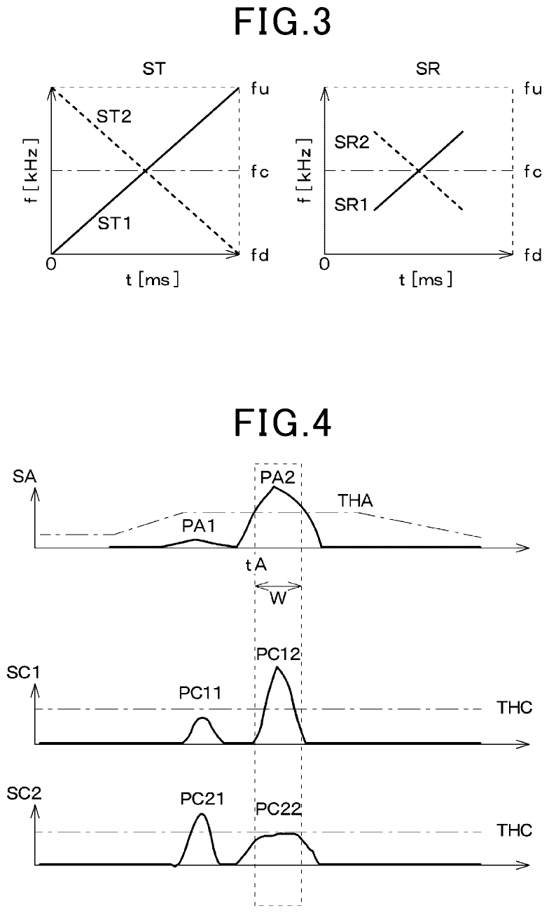

Here, in consideration of the transmission signal ST not equaling the reception signal SD due to the microphone properties, i.e., the frequency properties of the transceiver 11, the reference signals are, as illustrated in FIG. 3, set to have a narrower frequency band than the frequency band of the transmission signals ST in the present embodiment. In more detail, FIG. 3 illustrates a correspondence relationship between the transmission signals ST and the reference signals when the up transmission signal ST1 and the down transmission signal ST2 are both linear chirp signals. In FIG. 3, the left transmission signals ST are identical to the transmission signals in FIG. 2B, and the right SR represents reference signals. As illustrated in FIG. 3, the first reference signal SR1 is set to have a part of the frequency properties of the up transmission signal ST1, specifically a frequency band corresponding to about half of the frequency band of the up transmission signal ST1 centered on the center frequency fc. The first reference signal SR1 has an identical inclination, i.e., variation of frequency per unit time, to the up transmission signal ST1. Similarly, the second reference signal SR2 is set to have a part of the frequency properties of the down transmission signal ST2, specifically a frequency band corresponding to about half of the frequency band of the down transmission signal ST2 centered on the center frequency fc. The second reference signal SR2 has an identical inclination to the down transmission signal ST2.

Referring again to FIG. 1, the correlation signal generator 134 is provided so as to generate a correlation signal indicating a correlation, i.e., similarity in frequency properties, between the reference signal corresponding to the transmission signal ST and the filtered signal SF. Specifically, the correlation signal generator 134 is configured to generate a correlation signal based on the filtered signal SF, using a well-known method, and output the correlation signal to the signal determiner 14. The correlation signal generator 134 has a configuration of a correlation filter (for example, a matched filter) for calculation of correlation processing between the reception signal SD, i.e., the filtered signal SF, and the reference signal. Examples of a method of generating a correlation signal, i.e., calculating a correlation, include a method of rotating the vectors of complex reception signals based on reference signals, followed by summation of the rotated vectors (see, for example, JP 2022-124824 A). A correlation filter such as a matched filter is a well-known technique at the time of filing of the present application (see, for example, JP 2008-256568 A). Accordingly, a further detail is omitted on the configuration of the correlation signal generator 134 and the method of calculating a correlation signal performed by the correlation signal generator 134.

In the present embodiment, a plurality of correlation signal generators 134 are provided in correspondence with the plurality of types of transmission signals ST that the transmission signal generator 12 is capable of generating and outputting. That is, the correlation signal generator 134 includes N correlation filters when the transmission signal generator 12 has a configuration of being capable of generating and outputting N types of transmission signals ST. Specifically, in correspondence with the transmission signal generator 12 selectively outputting one of the two types of transmission signals ST, the up transmission signal ST1 and the down transmission signal ST2, the correlation signal generator 134 includes, as the correlation filters, a first correlation signal generator 134a and a second correlation signal generator 134b. The first correlation signal generator 134a is provided in correspondence with the up transmission signal ST1. The second correlation signal generator 134b is provided in correspondence with the down transmission signal ST2. In correspondence with these correlation signal generators, the reference signal output section 133 outputs the first reference signal SR1 to the first correlation signal generator 134a, and the second reference signal SR2 to the second correlation signal generator 134b. The first correlation signal generator 134a is configured to generate a first correlation signal SC1 indicating a correlation between the first reference signal SR1 and the filtered signal SF, and output the first correlation signal SC1 to the signal determiner 14. Similarly, the second correlation signal generator 134b is configured to generate a second correlation signal SC2 indicating a correlation between the second reference signal SR2 and the filtered signal SF, and output the second correlation signal SC2 to the signal determiner 14.

The signal determiner 14 is provided so as to perform a code determination based on the correlation signals generated and output by the correlation signal generators 134. The “code determination” is a determination on whether the received wave received this time has a frequency change mode corresponding to the frequency modulation mode of the probe waves transmitted this time (i.e., immediately before the reception of the received waves). In other words, the code determination is a determination on whether the received waves received this time by the receiver 112 of the objection detection apparatus 10 are reflected waves formed when the probe waves, which have been transmitted by the transmitter 111 of the object detection apparatus 10, are reflected by the object B. In the cases in which the determination is YES, meaning the cases in which the received waves received this time by the receiver 112 of the objection detection apparatus 10 are reflected waves formed when the probe waves, which have been transmitted from the transmitter 111 of the object detection apparatus 10, are reflected by the object B, the received waves are hereinafter called “regular waves”. In contrast, when the determination is NO, the received waves are hereinafter called “interference”. The signal determiner 14 has a configuration of a vehicle-mounted microcomputer including a CPU and the like exhibiting a prescribed function by executing a program, and/or of a hardware circuit configured to exhibit a prescribed function.

In the present embodiment, the signal determiner 14 is configured to perform a code determination by comparing a plurality of correlation signals. Specifically, in the cases in which the transmission signal generator 12 outputs an up transmission signal ST1 as the first transmission signal, the signal determiner 14 determines that the received waves are regular waves when the first correlation signal SC1 shows a higher correlation than the second correlation signal SC2; whereas the signal determiner 14 determines that the received waves are interference when the first correlation signal SC1 shows a lower correlation.

In more detail, the signal determiner 14 is configured to perform a code determination by comparing a plurality of correlation signals in a code determination range that is a time range set based on the amplitude signal SA. Specifically, the signal determiner 14 determines, between a start point and a time width of the code determination range, at least the start point based on the amplitude signal SA. The signal determiner 14 determines whether the received waves are regular waves or interference based on the result of comparing the maximum value of the first correlation signal SC1 with the maximum value of the second correlation signal SC2 detected in the code determination range which has been determined as above. That is, in the cases in which the transmission signal ST is an up transmission signal ST1, the signal determiner 14 determines that the received waves are regular waves, when the maximum value of the first correlation signal SC1 is greater; whereas the signal determiner 14 determines that the received waves are interference, when the maximum value of the second correlation signal SC2 is greater. Similarly, in the cases in which the transmission signal ST is a down transmission signal ST2, the signal determiner 14 determines that the received waves are regular waves, when the maximum value of the second correlation signal SC2 is greater; whereas the signal determiner 14 determines that the received waves are interference, when the maximum value of the first correlation signal SC1 is greater.

The controller 15 is provided so as to control the entire operation of the object detection apparatus 10. The controller 15 has a configuration of a vehicle-mounted microcomputer including a CPU and the like exhibiting a prescribed function by executing a program, and/or of a hardware circuit configured to exhibit a prescribed function. The controller 15 is, in a communicable manner, electrically connected to an unillustrated external apparatus mounted to the own vehicle. The external apparatus is, for example, electronic control equipment (i.e., for example, an autonomous driving ECU) that performs a driving control of the own vehicle, using a result of object detection performed by the object detection apparatus 10. The ECU is an abbreviation for Electronic Control Unit. The controller 15 outputs, to the transmission signal generator 12, a setting signal for setting, or selecting a code, i.e., a transmission signal ST output to the transmitter 111, or a transmission instruction signal for controlling the start or the stop of transmission of probe waves. The controller 15 also receives a code determination result from the signal determiner 14. Further, the controller 15 also generates a detection signal corresponding to the result of detecting the object B, based on the code determination result received, and outputs the detection signal toward the external apparatus.

### First Embodiment: Summary of Operation

Hereinafter, with reference to drawings, the summary of operation of the configuration in the present embodiment will be described together with effects exhibited by the configuration. In the following description, an apparatus configuration of the object detection apparatus 10 according to the present embodiment, and an object detecting method and a computer program executed by the apparatus configuration are sometimes collectively and simply called the “present embodiment”.

The controller 15 outputs a setting signal and a transmission instruction signal to the transmission signal generator 12 when prescribed object detection conditions are satisfied. The “prescribed object detection conditions” include, for example, a driving state of the own vehicle (i.e., shift position, vehicle speed, and the like). In reaction to the output, the transmission signal generator 12 generates one of a plurality of types of generable transmission signals ST based on the setting signal, and outputs the generated signal to the transmitter 111. The transmitter 111 transmits, to an external space of the own vehicle, probe waves as ultrasonic waves having the frequency thereof modulated based on the frequency change mode of the transmission signal ST input. The probe waves are encoded through frequency modulation based on the transmission signal ST.

The receiver 112 receives received waves as ultrasonic waves, and then generates a reception signal SD that is a signal corresponding to the amplitude and the frequency of the received waves and outputs the reception signal SD to the reception signal processing section 13. In the reception signal processing section 13, the filter 131 filters the reception signal SD, and generates a filtered signal SF. The filtered signal SF generated is input to the amplitude signal generator 132 and the correlation signal generator 134. The amplitude signal generator 132 transforms the filtered signal SF to an amplitude signal SA, and outputs the amplitude signal SA to the signal determiner 14. The correlation signal generator 134 generates a correlation signal indicating a correlation between a reference signal output from the reference signal output section 133, and the filtered signal SF, and outputs the correlation signal to the signal determiner 14.

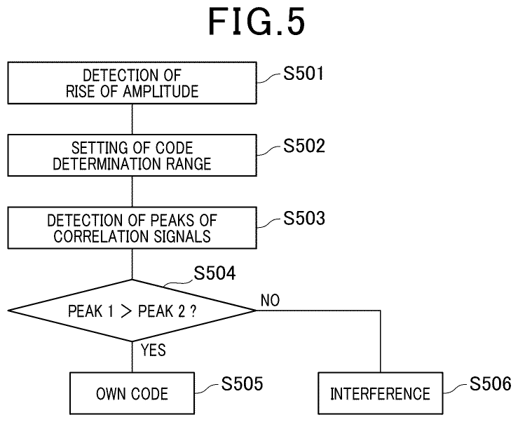

The signal determiner 14 performs a code determination based on the amplitude signal SA and the correlation signal generated by the reception signal processing section 13. Specifically, the signal determiner 14 sets a code determination range based on the amplitude signal SA. The “code determination range” is a time range set for the amplitude signal SA and the correlation signal, whose values vary over time, to be used for the code determination, the “code determination range” being specifically a time range for detecting or extracting values used for the code determination. For example, as illustrated in FIG. 4, the signal determiner 14 sets, as the code determination range, a prescribed time width W having, as the start point, a point tA at which the amplitude signal SA has, after a rise thereof, reached an amplitude threshold THA. In the present specific example, the amplitude threshold THA is set to be variable according to the lapse of time. That is, the amplitude threshold THA has a property of being held constant at a low value, then increased to a high value and held at the high value for a prescribed period, and thereafter decreased. Then, the signal determiner 14 performs the code determination based on the correlation signals in the code determination range set.

Here, for example, when the code determination range is greatly shifted from the center of the reflected waves, the code determination is likely to be erroneous. Such an error is typically generated, for example, when the amplitude of the reflected wave is very large and saturated, or when the waveform of the amplitude signal is disturbed by a plurality of reflected waves. Therefore, in the present embodiment, the transmission signal generator 12 is provided so as to selectively output one of a plurality of types of transmission signals ST. A plurality of correlation signal generators 134 are provided in correspondence with the plurality of types of transmission signals ST. Then, the signal determiner 14 performs the code determination by comparing a plurality of correlation signals generated by the correlation signal generators 134.

Specifically, in the example illustrated in FIG. 4, the amplitude signal SA includes a sub amplitude peak PA1 corresponding to interference, and a main amplitude peak PA2 corresponding to the regular waves. In this case, the first correlation signal SC1 includes a first sub correlation peak PC11 corresponding to the sub amplitude peak PA1, and a first main correlation peak PC12 corresponding to the main amplitude peak PA2. The first sub correlation peak PC11 is a peak not exceeding a correlation threshold THC. The first main correlation peak PC12 is a peak exceeding the correlation threshold THC. On the other hand, the second correlation signal SC2 includes a second sub correlation peak PC21 corresponding to the sub amplitude peak PA1, and a second main correlation peak PC22 corresponding to the main amplitude peak PA2. The second sub correlation peak PC21 is a peak exceeding the correlation threshold THC. The second main correlation peak PC22 is a peak not exceeding the correlation threshold THC. In this respect, as illustrated in FIG. 4, the code determination range is set so as not to include the first sub correlation peak PC11 and the second sub correlation peak PC21, but so as to include the first main correlation peak PC12 and the second main correlation peak PC22. In the code determination range set, the first main correlation peak PC12 exceeds the correlation threshold THC, whereas the second main correlation peak PC22 does not exceed the correlation threshold THC. That is, the first main correlation peak PC12 is greater than the second main correlation peak PC22. Therefore, in this case, the signal determiner 14 determines that the main amplitude peak PA2 corresponding to the first main correlation peak PC12 derives from reflected waves corresponding to the regular waves. In other words, in this case, the signal determiner 14 determines that the received waves corresponding to the main amplitude peak PA2 are the regular waves.

FIG. 5 illustrates a flowchart corresponding to the determination method described above. In this operational example, the transmission signal ST is a first transmission signal, i.e., an up transmission signal ST1. In the flowchart of FIG. 5, “S” is an abbreviation for “step”. The same applies to the other flowcharts described later.

With reference to FIG. 5, first, in step S501, the signal determiner 14 detects a rise of an amplitude signal SA (i.e., tA illustrated in FIG. 4). Next, in step S502, the signal determiner 14 sets a code determination range based on the rise of the amplitude signal SA detected in step S501. Subsequently, in step S503, the signal determiner 14 detects peaks of correlation signals in the code determination range set in step S502. Specifically, the signal determiner 14 detects, in the code determination range, a peak 1 that is a peak of a first correlation signal SC1, and a peak 2 that is a peak of a second correlation signal SC2. Then, in step S504, the signal determiner 14 compares the peaks of the plurality of correlation signals detected in step S503. Specifically, the signal determiner 14 compares the magnitude between the peaks 1 and 2. When the peak 1 is greater than the peak 2 (i.e., step S504=YES), the signal determiner 14 performs the processing of step S505. In step S505, the signal determiner 14 determines that the code included in the received waves of this time is an own code, i.e., that the received waves of this time are regular waves. The “own code” is a code, i.e., a frequency modulation mode, included in the probe waves that have actually been transmitted. Specifically, for example, when, with the code of the up transmission signal ST1 set to “1”, and the code of the down transmission signal ST2 to “0”, the transmission signal ST corresponding to the probe waves actually transmitted this time is an up transmission signal ST1, the own code is “1”. On the other hand, when the peak 1 is smaller than the peak 2 (i.e., step S504=NO), the signal determiner 14 performs the processing of step S506. In step S506, the signal determiner 14 determines that the code included in the received waves of this time is not an own code, i.e., that the received waves of this time are interference.

As described above, in the present embodiment, the code determination is performed by comparing a plurality of correlation signals (i.e., the first correlation signal SC1 and the second correlation signal SC2) respectively corresponding to a plurality of transmission signals ST (i.e., the first transmission signal and the second transmission signal). Thereby, the accuracy of the code determination is much more improved. In addition, by performing the code determination based on a rise of the amplitude signal SA, erroneous determinations attributed to received waves having a small amplitude, such as reflection by the road surface, can excellently be suppressed. Further, by using a so-called shift chirp illustrated in FIG. 2C, the accuracy of the code determination is much more improved.

In the meantime, the transmission signal ST does not equal the reception signal SD due to the microphone properties of the transducer 113 that is a resonance ultrasonic microphone, i.e., due to the frequency properties of the transceiver 11. That is, for example, the probe waves have a lower frequency followability as the frequency of the drive signal gets further away from the resonance frequency. Accordingly, a deviation is generated between the frequency properties of the transmission signal ST and the frequency properties of the probe waves actually transmitted. Accordingly, a deviation is also generated between the frequency properties of the reception signal SD generated from reflected waves of the probe waves, and the frequency properties of the transmission signal ST. Therefore, the frequency band of the transmission signal ST can be set wider than the frequency band of the microphone. The “frequency band of the microphone” is a frequency range of 0 to −3 dB when the gain of the transceiver 11 in the resonance frequency is set to 0 db. In this respect, as illustrated in FIG. 3, by correcting and setting the reference signal to a narrower frequency band than the frequency band of the transmission signal ST, the accuracy of the code determination is much more improved.

A delay is generated in filtering and correlation calculation. That is, with reference to FIG. 4, a gap can usually be generated along the time axis between the waveform of the amplitude signal SA, the waveform of the first correlation signal SC1, and the waveform of the second correlation signal SC2. Therefore, the signal determiner 14 performs the code determination after correcting at least the delay generated in filtering and correlation calculation used for generating a correlation signal used for the code determination. FIG. 4 illustrates a relationship between the waveforms after the delay is compensated by the correction. The correction can be performed using, for example, a conformance correction value obtained by a conformance test using experiment or computation simulation. Thereby, the accuracy of the code determination can be much more improved.

### First Embodiment: Modified Example 1

Hereinafter, one applicable modified example of the first embodiment will be described. In the following description of the present modified example, components different from the first embodiment will mainly be described. The components that are identical to or equivalent to each other between the first embodiment and the present modified example have an identical reference sign assigned thereto. Accordingly, in the following description of the present modified example, the description of the first embodiment can be employed as appropriate for the constituent elements having identical reference signs to the first embodiment, unless there is a technical contradiction or particular additional description. The same applies to other modified examples, a second embodiment, a third embodiment, and the like described later.

In the peak detection performed in step S503, only a peak greater than or equal to the correlation threshold THC may be detected. In the peak detection, when there is no peak, a maximum value in the code determination range is used. In this case, the maximum value to be detected may only be a value greater than or equal to the correlation threshold THC. Here, the amplitude signal SA and the correlation signals have different behaviors. Therefore, the signal determiner 14 may use different values between the amplitude threshold THA that is a threshold for determination of the amplitude signal SA, and the correlation threshold THC that is a threshold for determination of the correlation signals. Specifically, for example, the amplitude threshold THA can be set to change over time. In contrast, the correlation threshold THC can be set as a constant value that does not change over time. As described above, by changing the change mode associated with the lapse of time between the amplitude threshold THA and the correlation threshold THC, the accuracy of the code determination can be much more improved.

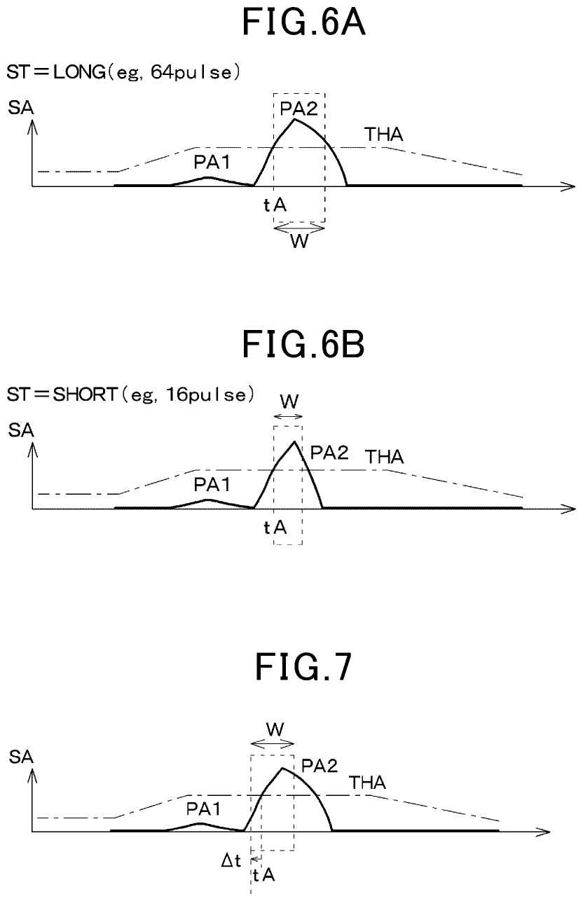

The signal length of the transmission signal ST can be changed according to the specification of the apparatus, the scene, or the like. Therefore, in the present modified example, the signal determiner 14 sets the time width W of the code determination range based on the signal length, i.e., the pulse number, of the transmission signal ST. Specifically, FIG. 6A illustrates a long signal-length case (for example, 64 pulses). On the other hand, FIG. 6B illustrates a short signal-length case (for example, 16 pulses). With reference to FIGS. 6A and 6B, the time width W of the code determination range is set wider (i.e., longer) in the long signal-length case than in the short signal-length case. Thereby, the accuracy of the code determination can be much more improved. The time width W may be set by two levels, in the long signal-length case and the short signal-length case, i.e., according to the selection between a value for the cases in which the signal length is longer than a prescribed value and a value for the cases in which the signal length is smaller than or equal to the prescribed value. Alternatively, the time width W may be set by a plurality of levels corresponding to the signal lengths.

### First Embodiment: Modified Example 3

Hereinafter, another modified example will be described with reference to FIGS. 1 and 7. In the present modified example, the start point of the code determination range can be set to a point tM obtained by shifting, i.e., correcting, the point tA at which the amplitude signal SA has, after a rise thereof, reached the amplitude threshold THA. The shift amount (i.e., the correction amount) Δt=tA−tM can be acquired, for example, by a conformance test using experiment or computation simulation in consideration of the delay described above. Alternatively, for example, At can be set to be variable according to the operation conditions such as vehicle speed. Alternatively, for example, as described later, Δt can be set based on the change rate (i.e., the inclination of the tangent) of the amplitude signal SA at the point tA at which the amplitude signal SA has, after an increase thereof, reached the prescribed amplitude threshold THA. Thereby, the accuracy of the code determination can be much more improved.

### First Embodiment: Modified Example 4

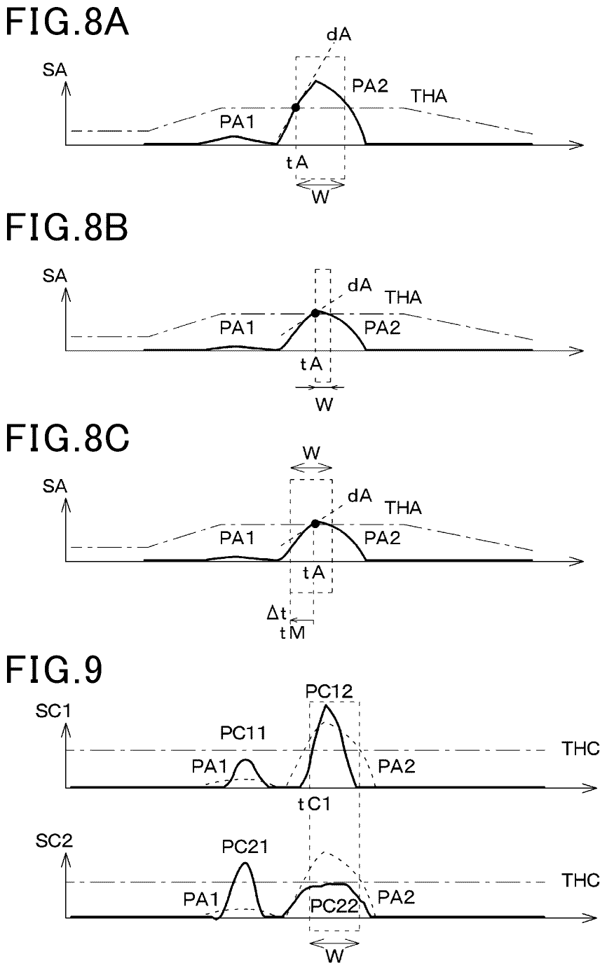

Hereinafter, another modified example will be described with reference to FIGS. 1, 8A, 8B, and 8C. In the present modified example, the signal determiner 14 sets the code determination range based on a change rate dA of the amplitude signal SA at the point tA at which the amplitude signal SA has, after an increase thereof, reached the prescribed amplitude threshold THA. Specifically, FIG. 8A illustrates a case in which the change rate dA is large. On the other hand, FIGS. 8B and 8C illustrate cases in which the change rate dA is small. As illustrated in FIGS. 8A and 8B, the time width W of the code determination range can be set wider (i.e., longer) when the change rate dA is large than when the change rate dA is small. The time width W may be set in two levels according to when the change rate dA is large and when the change rate dA is small, or may be set in a plurality of levels. Alternatively, as illustrated in FIGS. 8A and 8C, when the change rate dA is small, the code determination range can be shifted to the “near side”, i.e., the earlier side, in the time axis. One of the change or the temporal shift of the time width W can be used, or both thereof can be used in combination. As described above, by setting the time width W or the timing of the code determination range based on the change rate dA, the accuracy of the code determination can be much more improved.

### First Embodiment: Modified Example 5

Hereinafter, another modified example will be described with reference to FIGS. 1, 9, and 10. In the time charts of correlation signals in FIG. 9, the amplitude signal SA is, for reference, also shown by a dotted line. In the present modified example, the signal determiner 14 sets the code determination range based on the point at which a correlation signal has, after an increase thereof, reached the correlation threshold THC. Specifically, when the transmission signal ST is an up transmission signal ST1, i.e., a first transmission signal, the signal determiner 14 detects, as illustrated in FIG. 9, a point tC1 at which a rising part of the first main correlation peak PC12 has reached the correlation threshold THC. The signal determiner 14 also sets, as the code determination range, a prescribed time width W having the point tC1 as the start point. Then, the signal determiner 14 performs the code determination based on the correlation signals in the code determination range set. Specifically, the signal determiner 14 performs the code determination by comparing the first main correlation peak PC12 and the second main correlation peak PC22 in the code determination range set, and determining whether the first main correlation peak PC12 is greater than or equal to the correlation threshold THC. Thereby, the accuracy of the code determination can be much more improved.

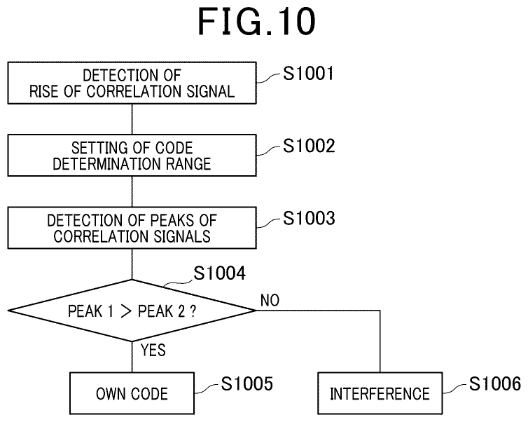

FIG. 10 illustrates a flowchart corresponding to the determination method described above. With reference to FIG. 10, first, in step S1001, the signal determiner 14 detects a rise of a correlation signal (i.e., tC1 illustrated in FIG. 9). Next, in step S1002, the signal determiner 14 sets a code determination range based on the rise of the correlation signal detected in step S1001. Subsequently, in step S1003, the signal determiner 14 detects peaks of correlation signals in the code determination range set in step S1002. The peak detection performed in step 1003 is the same as in step S503 in FIG. 5. The processing contents of steps S1004 to S1006 are respectively the same as of steps S504 to S506 in FIG. 5.

### Second Embodiment

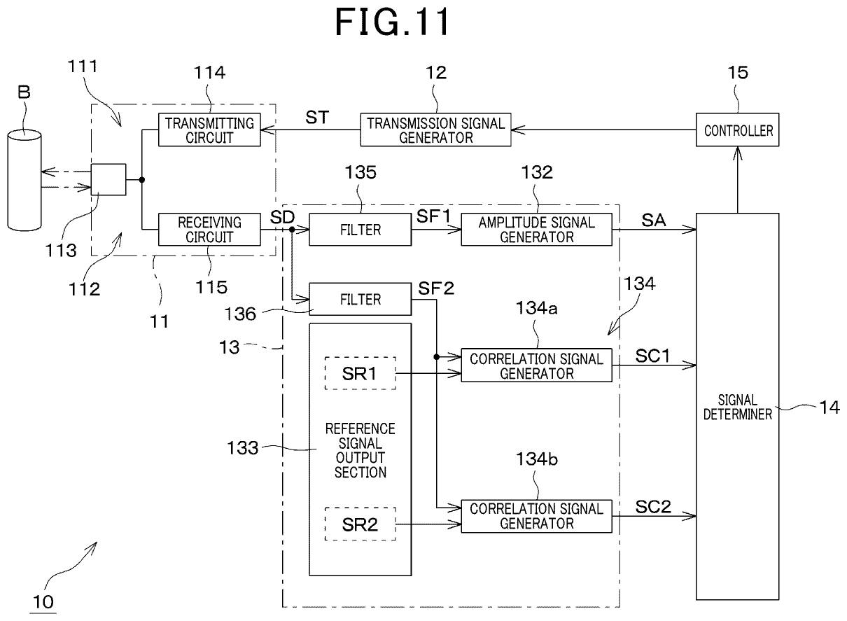

A value Q of the filter 131 illustrated in FIG. 1 is preferred to be smaller when the correlation is obtained, but the value Q is preferred to be greater when the amplitude signal SA is generated. Therefore, it is suitable to use different filter values Q for generating the amplitude signal SA, and for generating the correlation signals, i.e., the first correlation signal SC1 and the second correlation signal SC2. FIG. 11 illustrates a schematic configuration of an object detection apparatus 10 according to a second embodiment obtained by altering the first embodiment from these viewpoints. With reference to FIG. 11, the object detection apparatus 10 includes a first filter 135 and a second filter 136. That is, the present embodiment corresponds to a configuration obtained by splitting the filter 131 in the first embodiment into a filter for generating an amplitude signal SA and a filter for generating correlation signals. The first filter 135 and the second filter 136 have different values Q. That is, the value Q is set greater in the first filter 135 than in the second filter 136.

In the present embodiment, the first filter 135 is provided so as to filter a reception signal SD, and output, to an amplitude signal generator 132, a first filtered signal SF1 that is the reception signal SD having undergone the filtering. The second filter 136 is provided so as to filter a reception signal SD, and output, to a correlation signal generator 134, a second filtered signal SF2 that is the reception signal SD having undergone the filtering.

In this configuration, the amplitude signal generator 132 generates an amplitude signal SA based on a first filtered signal SF1 obtained by filtering a reception signal SD through the first filter 135 having a great value Q. On the other hand, the correlation signal generator 134 generates correlation signals, i.e., a first correlation signal SC1 and a second correlation signal SC2 based on second filtered signals SF2 obtained by filtering reception signals SD through the second filter 136 having a small value Q. As described above, in the present embodiment, the apparatus configuration made as simple as possible enables the use of different filter values Q for generating the amplitude signal SA and for generating the correlation signals. Accordingly, the present embodiment can much more improve the accuracy of the code determination.

### Third embodiment

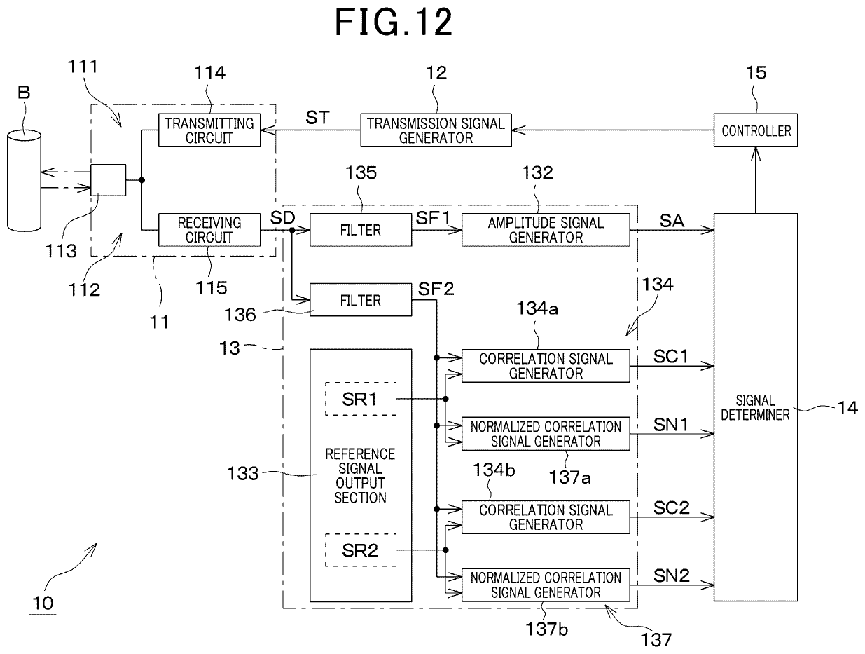

FIG. 12 illustrates a schematic configuration of an object detection apparatus 10 according to a third embodiment. In the present embodiment, a signal determiner 14 performs a code determination based on a normalized correlation signal obtained by calculating a correlation of a reference signal with a signal obtained by normalizing, for a constant amplitude, a second filtered signal SF2 output from a second filter 136. That is, a reception signal processing section 13 includes a normalized correlation signal generator 137 that performs so-called normalization correlation processing. The normalized correlation signal is a signal obtained by eliminating (i.e., reducing), from a correlation signal, an influence of amplitude of a reception signal SD. Specifically, in correspondence with a transmission signal generator 12 being capable of generating and outputting two types of transmission signals ST, an up transmission signal ST1 and a down transmission signal ST2, the normalized correlation signal generator 137 includes a first normalized correlation signal generator 137a and a second normalized correlation signal generator 137b. The first normalized correlation signal generator 137a is provided in correspondence with the up transmission signal ST1, i.e., a first correlation signal generator 134a. The first normalized correlation signal generator 137a is configured to generate a first normalized correlation signal SN1 obtained by calculating a correlation of a first reference signal SR1 with a signal obtained by normalizing a second filtered signal SF2, and output the first normalized correlation signal SN1 to the signal determiner 14. The second normalized correlation signal generator 137b is provided in correspondence with the down transmission signal ST2, i.e., a second correlation signal generator 134b. The second normalized correlation signal generator 137b is configured to generate a second normalized correlation signal SN2 obtained by calculating a correlation of a second reference signal SR2 with a signal obtained by normalizing a second filtered signal SF2, and output the second normalized correlation signal SN2 to the signal determiner 14.

Here, in order to suppress as much as possible the generation of a delay caused by correlation calculation and normalization calculation, the first normalized correlation signal generator 137a is provided in parallel with the first correlation signal generator 134a in the present embodiment. That is, the first normalized correlation signal generator 137a is configured to have input thereto the first reference signal SR1 and the second filtered signal SF2, normalize the amplitude of the second filtered signal SF2, then perform correlation calculation, and output the first normalized correlation signal SN1, which is a result of the calculation, to the signal determiner 14. In other words, the reception signal processing section 13 has a configuration enabling in parallel the generation of a correlation signal in the first correlation signal generator 134a and the generation of a normalized correlation signal in the first normalized correlation signal generator 137a. Similarly, the second normalized correlation signal generator 137b is provided in parallel with the second correlation signal generator 134b.

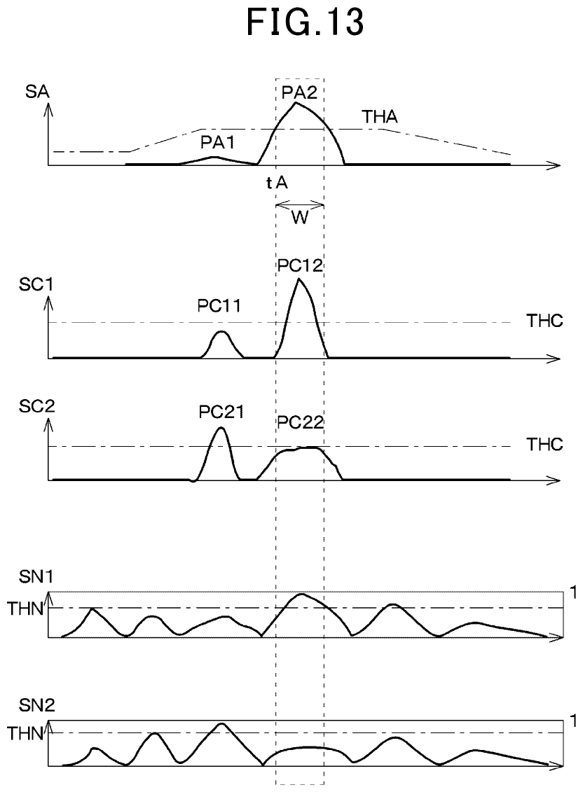

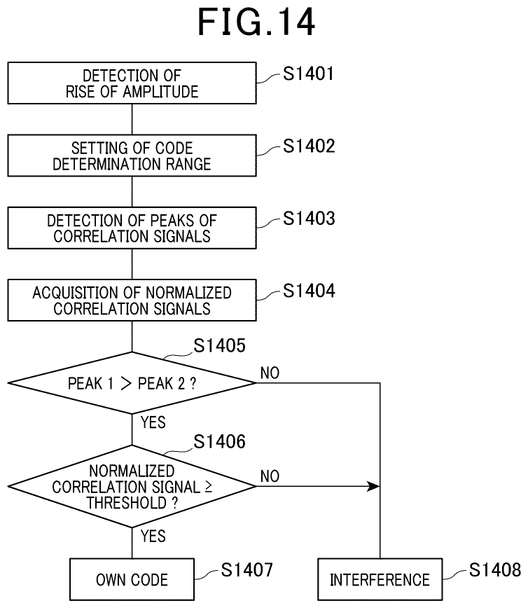

FIGS. 13 and 14 illustrate an operational example of performing, similarly to the first embodiment, a code determination with a code determination range based on a rise of an amplitude signal SA. In FIG. 13, a first normalized correlation signal SN1 is obtained by normalizing, for a constant amplitude, a second filtered signal SF2 output from the second filter 136, and then performing correlation calculation between the normalized signal and a first reference signal SR1. Similarly, a second normalized correlation signal SN2 is obtained by normalizing a second filtered signal SF2, and then performing correlation calculation between the normalized signal and a second reference signal SR2. In the present operational example, as illustrated in FIG. 13, the signal determiner 14 sets, as the code determination range, a prescribed time width W having, as the start point, a point tA at which an amplitude signal SA has, after a rise thereof, reached an amplitude threshold THA. Then, the signal determiner 14 performs a code determination based on the correlation signals in the code determination range set and the normalized correlation signals obtained by normalizing the correlation signals. Specifically, the signal determiner 14 detects peaks of correlation signals in the code determination range and compares the relative magnitude between the peaks, and checks normalized correlation signals and establishes a code when a normalized correlation signal is greater than or equal to a prescribed normalization threshold THN.

The amplitude of a correlation signal changes due to not only the correlation level between a reception signal SD and a reference signal, but also the amplitude of the reception signal SD, and the amplitude of the correlation signal increases along with the increase of the amplitude of the reception signal SD. Therefore, there has been a concern that when a reflected wave having a very large amplitude is received, the correlation signal increases the amplitude thereof and exceeds the threshold, causing an erroneous determination. However, the present embodiment improves the accuracy of determination by the use of a correlation signal obtained by eliminating an influence of amplitude of a reception signal SD.

### Modified Example 1 of Third Embodiment

The normalized correlation signals may be signals obtained by dividing the correlation signals by the amplitude signal SA. In this case, the first normalized correlation signal SN1 is obtained by dividing the first correlation signal SC1 by the amplitude signal SA, and thus normalizing the first correlation signal SC1. That is, SN1=SC1/SA. Similarly, the second normalized correlation signal SN2 is obtained by dividing the second correlation signal SC2 by the amplitude signal SA, and thus normalizing the second correlation signal SC2. The normalization processing can give a signal independent of the amplitude of the reception signal SD.

### Modified Example 2 of Third Embodiment

The normalized correlation signals may be signals obtained by normalizing the correlation signals using the maximum values of the correlation signals. In this case, the first normalized correlation signal SN1 is obtained by, with the maximum value of the first correlation signal SC1 set to “1”, normalizing the first correlation signal SC1. That is, SN1=SC1/SC1 (MAX). Similarly, the second normalized correlation signal SN2 is obtained by, with the maximum value of the second correlation signal SC2 set to “1”, normalizing the second correlation signal SC2. The normalization processing can give a signal obtained with the maximum value of the correlation signal set to 1 even when the amplitude of the reception signal SD is large. A normalization method has, as described in JP 2022-124824 A and the like, been publicly known or well-known at the time of filing of the present application. Therefore, a further detail on the normalization method is omitted.

FIG. 14 illustrates a flowchart corresponding to the code determination method described above. The processing contents of steps S1401 to S1403 illustrated in FIG. 14 are respectively the same as of steps S501 to S503 illustrated in FIG. 5. In step S1404, the signal determiner 14 acquires normalized correlation signals from the normalized correlation signal generator 137. Then, in step S1405, the signal determiner 14, compares, similarly to step S504 illustrated in FIG. 5, the peaks of a plurality of correlation signals detected in step S1403. Specifically, the signal determiner 14 compares the magnitude of peak 1 with that of peak 2. When the peak 1 is greater than the peak 2 (i.e., step S1405=YES), the signal determiner 14 performs the processing of step S1406. In step S1406, the signal determiner 14 determines whether the normalized correlation signal corresponding to the peak 1 is greater than or equal to the normalization threshold THN, i.e., whether the value obtained by normalizing the first main correlation peak PC12 in FIG. 13 is greater than or equal to the normalization threshold THN. When the normalized correlation signal is greater than or equal to the normalization threshold THN (i.e., step S1406=YES), the signal determiner 14 performs the processing of step S1407. In step S1407, the signal determiner 14 determines that the code included in the received wave of this time is an own code, i.e., that the received wave of this time is a regular wave. In contrast, when the peak 1 is smaller than the peak 2 (i.e., step S1405=NO), or when the normalized correlation signal is smaller than the normalization threshold THN (i.e., step S1406=NO), the signal determiner 14 performs the processing of step S1408. In step S1408, the signal determiner 14 determines that the received wave of this time is interference.

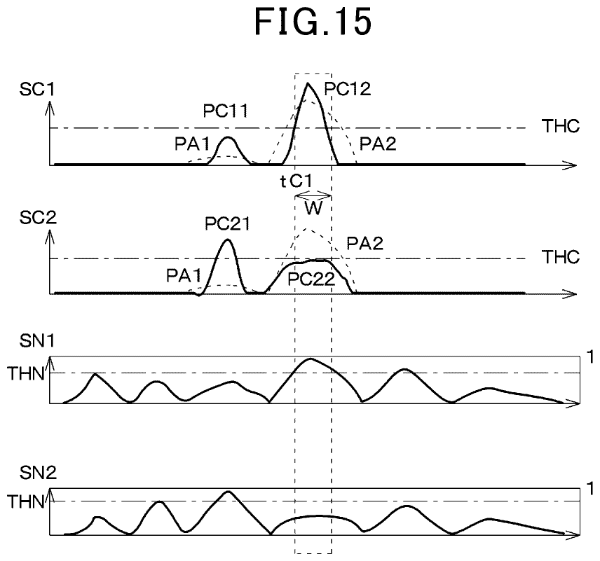

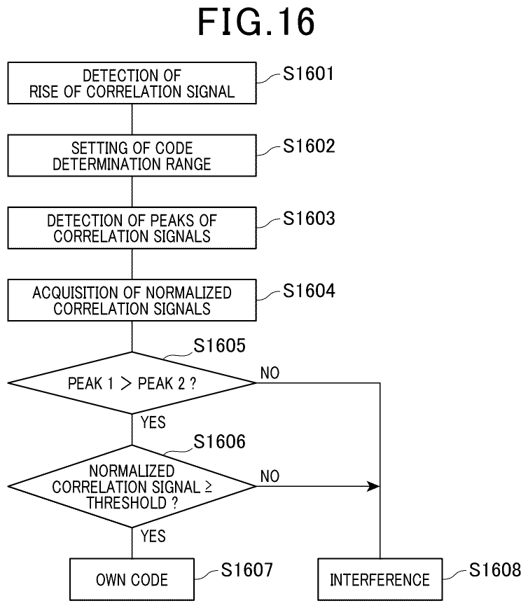

FIGS. 15 and 16 illustrate an operational example of performing a code determination with a code determination range based on a rise of a correlation signal. Specifically, in the present operational example, when the transmission signal ST is an up transmission signal ST1, i.e., a first transmission signal, the signal determiner 14 detects, as illustrated in FIG. 15, a point tC1 at which a rising part of the first main correlation peak PC12 has reached the correlation threshold THC. The signal determiner 14 also sets, as the code determination range, a prescribed time width W having the detected point tC1 as the start point. Then, the signal determiner 14 performs the code determination based on the correlation signals and the normalized correlation signals in the code determination range set. Thereby, the accuracy of the code determination can be much more improved.

FIG. 16 illustrates a flowchart corresponding to the code determination method described above. With reference to FIG. 16, first, in step S1601, the signal determiner 14 detects a rise of a correlation signal (i.e., tC1 illustrated in FIG. 15). Next, in step S1602, the signal determiner 14 sets a code determination range based on the rise of the correlation signal detected in step S1601. That is, the processing contents of steps S1601 and S1602 are respectively the same as of steps S1001 and S1002 illustrated in FIG. 10. The processing contents of steps S1603 to S1608 are respectively the same as of steps S1403 to S1408 illustrated in FIG. 14.

In the peak detection performed in steps S1403 and S1603, only a peak greater than or equal to the correlation threshold THC may be detected. In the peak detection, when there is no peak, a maximum value in the code determination range is used. In this case, the maximum value to be detected may only be a value greater than or equal to the correlation threshold THC. Here, the amplitude signal SA, the correlation signals, and the normalized correlation signals have different behaviors. Therefore, the signal determiner 14 may use different values between the amplitude threshold THA that is a threshold for determination of the amplitude signal SA, the correlation threshold THC that is a threshold for determination of the correlation signals, and the normalization threshold THN that is a threshold for determination of the normalized correlation signals. Specifically, for example, as illustrated in FIG. 13, the amplitude threshold THA can be set to change over time. In contrast, the correlation threshold THC and the normalization threshold THN can be set as a constant value that does not change over time. In FIGS. 13 and 15, the normalization threshold THN can be set to a value different from the ratio of the height of the correlation threshold THC to the height of the first main correlation peak PC12. Thereby, the accuracy of the code determination can be much more improved.

For example, when an oncoming vehicle, which is another vehicle having sonar from another company mounted thereon, comes from the direction opposite to the own vehicle, and the receiver 112 of the object detection apparatus 10 of the own vehicle receives, as received waves, ultrasonic waves transmitted from the oncoming vehicle, the amplitude of the received waves is greatly increased. As a result, the increase of a correlation signal not including an own code but including a false code is likely to cause an erroneous determination. In this respect, the present embodiment enables excellent suppression of the generation of erroneous determinations by the use of the normalized correlation signals.

### Other Modified Examples

The present disclosure is not to be limited to the descriptions of the embodiments and modified examples described above. That is, the embodiments and modified examples can also be further altered.

The present disclosure is not limited to the apparatus configurations described in the embodiments and modified examples. Specifically, for example, the object detection apparatus 10 is not limited to the vehicle-mounted configuration (i.e., the configuration in which the object detection apparatus 10 is mounted to a vehicle). Accordingly, the object detection apparatus 10 can also be mounted to, for example, a water vehicle such as a vessel, and an air vehicle such as a plane.

The transceiver 11 is not limited to the so-called “transmission and reception integrated” configuration that enables transmission and reception of ultrasonic waves by the single transducer 113. That is, for example, a transmission transducer 113 electrically connected to the transmitting circuit 114 and a reception transducer 113 electrically connected to the receiving circuit 115 may separately be provided.

As described above, all or a part of the components of the object detection apparatus 10 that perform calculation and a determination can be configured as an vehicle-mounted microcomputer including a CPU, a ROM, a RAM, a non-volatile memory, an interface, and the like. The “non-volatile memory” is a memory having a function of enabling rewriting of the storage contents at power-on, but storing the storage contents at power-off, and examples of the memory include a flash memory and a hard disk. Alternatively, all or a part of the components may be configured to include a hardware circuit (for example, an ASIC or a FPGA) configured to enable the operation described above. The ASIC is an abbreviation for Application Specific Integrated Circuit. The FPGA is an abbreviation for Field Programmable Gate Array.

As described above, the functional configurations and methods described above may be implemented by a dedicated computer provided so as to include a processor, which is programmed to perform one or a plurality of functions embodied by a computer program, and a memory. Alternatively, the functional configurations and methods may be implemented by a dedicated computer provided so as to include a processor formed of one or more dedicated hardware logic circuits. Alternatively, the functional configurations and methods may be implemented by one or more dedicated computers configured to include a combination of a processor, which is programmed to perform one or a plurality of functions, and a memory, with a processor formed of one or more hardware logic circuits. The computer program may be, as instructions to be performed by a computer, stored in a computer-readable non-transitory tangible storage medium. That is, the functional configurations and methods can be expressed as a computer program including a procedure for implementing these configurations and methods, or a non-transitory tangible storage medium storing the program. The non-transitory tangible storage medium corresponds to, for example, a ROM, a RAM, a non-volatile memory, a DVD, a CD-ROM, or the like. The program can be downloaded or upgraded through V2X communication. The V2X is an abbreviation for Vehicle to X. Alternatively, this program can be downloaded or upgraded through a terminal device provided in a factory for producing mobile objects such as a vehicle, a maintenance factory, a dealer, or the like.

The transmission signal generator 12 and the reception signal processing section 13 can be provided in an identical substrate and thereby integrated as a module. The same applies to the reception signal processing section 13 and the signal determiner 14. The same applies to the signal determiner 14 and the controller 15. Accordingly, for example, the transmission signal generator 12, the reception signal processing section 13, the signal determiner 14, and the controller 15 may be integrated as a module in an identical substrate, a specific signal processor such as the filter 131 may be mounted as a hardware circuit, and the remaining components may be implemented by at least one CPU or MPU.

In the filter 131, the filtering of the reception signal SD may be performed using a well-known FIR filter or IIR filter. Alternatively, the filtering may be performed after the reception signal SD is transformed to a frequency component (i.e., a complex vector) through quadrature detection, discrete Fourier transform, FFT, or the like. When the filtering is performed after transformation to a complex vector, the subsequent stages, i.e., the amplitude signal generator 132, the correlation signal generator 134, and the normalized correlation signal generator 137 also perform various types of processing thereof on the complex vector. By performing the processing on the complex vector that is a frequency component, the scale of the hardware circuit can be reduced, or the amount of calculation by a CPU or MPU can be reduced.

The correlation signal generator 134 may include therein a reference signal. That is, the reference signal output section 133 can be omitted. Correlation signal generators 134 are provided as many as the types of transmission signals ST. Therefore, for example, when the transmission signal generator 12 is capable of generating and outputting four types of transmission signals ST, four correlation signal generators 134 can be provided. However, providing a plurality of correlation signal generators 134 does not necessarily mean providing a plurality of correlation signal generators 134 separately and in parallel. That is, for example, by switching the input between reference signals to one common correlation signal generator 134, a plurality of correlation signal generators 134 can be implemented through time division. In other words, in FIG. 1 and the like, the first correlation signal generator 134a and the second correlation signal generator 134b can be integrated. The same applies to the normalized correlation signal generator 137 in FIG. 12.

The normalized correlation signal generator 137 can also be applied to the configuration illustrated in FIG. 1. That is, the normalized correlation signal generator 137 may have an input of the filtered signal SF that is an output of the filter 131. With reference to FIG. 12, the normalized correlation signal generator 137 may be provided so as to normalize the correlation signals generated by the correlation signal generators 134. That is, the first normalized correlation signal generator 137a may be provided so as to have an input of the first correlation signal SC1 output from the first correlation signal generator 134a, and normalize the first correlation signal SC1. Similarly, the second normalized correlation signal generator 137b may be provided so as to normalize the second correlation signal SC2 output from the second correlation signal generator 134b.

The present disclosure is not limited to the operation modes described in the embodiments and modified examples described above. Specifically, for example, the frequency change mode of the transmission signal ST is not limited to the monotonic increase or monotonic decrease illustrated in FIG. 2A and the like, but may be step-like or the like. The up transmission signal ST1 only has to have a feature of generally increasing the frequency thereof, and may early have a part in which the frequency temporarily decreases, for a short period of time, from the start frequency at the center frequency fc or a frequency near the center frequency fc. The same applies to the down transmission signal ST2. The shift chirp signals illustrated in FIG. 2C can be altered to the curvaceous frequency change mode illustrated in FIG. 2A. Regarding the shift chirp signals illustrated in FIG. 2C, the frequency band of the up transmission signal ST1 may be set to fmd to fu, and the frequency of the down transmission signal ST2 to fmu to fd. Further, for one-time transmission of probe waves, a code string of a plurality of bits in which a plurality of codes are arrayed can be set. That is, for example, when the code of the first transmission signal is set to “1”, and the code of the second transmission signal to “0”, a code such as “1010” or “1101” can be applied to the probe waves. The present disclosure can also suitably be applied to such cases.

In the various types of determination processing, “greater than or equal to . . . ” and “exceeding . . . ” are replaceable with each other. Similarly, “ . . . smaller than” and “smaller than or equal to . . . ” are replaceable with each other. Terms having a common or similar meaning, such as “detection”, “measurement”, “calculation”, and “acquisition”, are also replaceable with each other unless technically contradicted. That is, for example, “acquiring” a characteristic value can include “calculating” the same value and inputting the same value.

The elements constituting the embodiments described above are, needless to say, not always essential except for, for example, the cases in which the elements are particularly mentioned to be essential, and the cases in which the elements are considered to be clearly essential in principle. Even when a numerical value for the number of constituent elements, the amount, a range, or the like is referred to, the present disclosure is never to be limited to the specific numerical value except for, for example, the cases in which the specific numerical value is particularly mentioned to be essential, and the cases in which the number, the amount, the range, or the like is clearly limited to the specific numerical value in principle. Similarly, when the shape, the direction, the positional relationship, or the like of a constituent element or the like is referred to, the present disclosure is never to be limited to the one referred to except for, for example, the cases in which the one referred to is particularly mentioned to be essential, and the cases in which the shape, the direction, the positional relationship, or the like is clearly limited to the specific one in principle.

Modified examples are not also limited to the examples described above. That is, all or a part of one embodiment can be combined with all or a part of another embodiment without technical contradiction. In addition, a plurality of modified examples can be combined with each other. Further, all or a part of the embodiments can be combined with all or a part of the modified examples.

### Aspects Included in the Present Disclosure

The present disclosure includes at least the following aspects.

### First Aspect

An object detection apparatus (10) including:
a transmission signal generator (12) capable of generating a plurality of types of transmission signals changing frequencies thereof over time, and configured to output a transmission signal to a transmitter (111), the transmission signal being one of the plurality of types of transmission signals, and the transmitter being configured to transmit a probe wave that is an ultrasonic wave having a frequency thereof modulated based on a frequency change mode of the transmission signal;
a correlation signal generator (134) configured to generate a correlation signal indicating a correlation between a reference signal corresponding to the transmission signal and a reception signal corresponding to a received wave, the received wave being an ultrasonic wave received by a receiver (112), and the reception signal being output by the receiver; and
a signal determiner (14) configured to perform a signal determination of determining, based on the correlation signal, whether the received wave has a frequency change mode corresponding to a frequency modulation mode of the probe wave, wherein
a plurality of the correlation signal generators are provided in correspondence with the plurality of types of transmission signals, and
the signal determiner is configured to perform the signal determination by comparing a plurality of the correlation signals.

### Second Aspect

The object detection apparatus according to the first aspect, wherein
the plurality of types of transmission signals include a first transmission signal and a second transmission signal,
one of the first transmission signal and the second transmission signal monotonically increases in frequency thereof, and another monotonically decreases in frequency thereof, and
the correlation signal generators are configured to generate a correlation signal indicating a correlation between a reference signal corresponding to the first transmission signal and the reception signal, and a correlation signal indicating a correlation between a reference signal corresponding to the second transmission signal and the reception signal.

### Third Aspect

The object detection apparatus according to the second aspect, wherein
the first transmission signal and the second transmission signal are set such that parts of frequency bands thereof overlap with each other, but remaining parts do not.

### Fourth Aspect

The object detection apparatus according to any one of the first to third aspects, further including an amplitude signal generator (132) configured to transform the reception signal to an amplitude signal, wherein
the signal determiner is configured to perform the signal determination by comparing the plurality of the correlation signals in a code determination range that is a time range set based on the amplitude signal.

### Fifth Aspect

The object detection apparatus according to the fourth aspect, wherein
the signal determiner is configured to set the code determination range based on a change rate of the amplitude signal at a point at which the amplitude signal has, after a rise thereof, reached a prescribed amplitude threshold.

### Sixth Aspect

The object detection apparatus according to the fourth or fifth aspect, wherein
different values are used for the amplitude threshold that is a threshold for determination of the amplitude signal, and a correlation threshold that is a threshold for determination of the correlation signals.

### Seventh Aspect

The object detection apparatus according to any one of the fourth to sixth aspects, wherein
the amplitude signal generator is configured to generate the amplitude signal based on a signal obtained by filtering the reception signal through a first filter (135),
the correlation signal generator is configured to generate the correlation signals based on a signal obtained by filtering the reception signal through a second filter (136), and
the first filter and the second filter have different values Q.

### Eighth Aspect

The object detection apparatus according to any one of the fourth to seventh aspects, wherein
the signal determiner is configured to set a time width of the code determination range based on a signal length of the transmission signal.

### Ninth Aspect

The object detection apparatus according to any one of the first to eighth aspects, wherein
the signal determiner is configured to perform the signal determination based on a normalized correlation signal obtained by eliminating, from the correlation signal, an influence of amplitude of the reception signal.

### Tenth Aspect

The object detection apparatus according to any one of the first to ninth aspects, wherein
the signal determiner is configured to perform the signal determination after correcting at least a delay generated in filtering and correlation calculation used for generating the correlation signal used for the signal determination.

### Eleventh Aspect

The object detection apparatus according to any one of the first to tenth aspects, wherein
the transmission signal is a linear chirp signal.

### Twelfth Aspect

The object detection apparatus according to any one of the first to eleventh aspects, wherein
the reference signal is set to have a narrower frequency band than a frequency band of the transmission signal.

1. An object detection apparatus comprising:
a transmission signal generator capable of generating a plurality of types of transmission signals changing frequencies thereof over time, and configured to output a transmission signal to a transmitter, the transmission signal being one of the plurality of types of transmission signals, and the transmitter being configured to transmit a probe wave that is an ultrasonic wave having a frequency thereof modulated based on a frequency change mode of the transmission signal;
a correlation signal generator configured to generate a correlation signal indicating a correlation between a reference signal corresponding to the transmission signal and a reception signal corresponding to a received wave, the received wave being an ultrasonic wave received by a receiver, and the reception signal being output by the receiver; and
a signal determiner configured to perform a signal determination of determining, based on the correlation signal, whether the received wave has a frequency change mode corresponding to a frequency modulation mode of the probe wave, wherein
a plurality of the correlation signal generators are provided in correspondence with the plurality of types of transmission signals, and
the signal determiner is configured to perform the signal determination by comparing a plurality of the correlation signals.

2. The object detection apparatus according to claim 1, wherein
the plurality of types of transmission signals include a first transmission signal and a second transmission signal,
one of the first transmission signal and the second transmission signal monotonically increases in frequency thereof, and another monotonically decreases in frequency thereof, and
the correlation signal generators are configured to generate a correlation signal indicating a correlation between a reference signal corresponding to the first transmission signal and the reception signal, and a correlation signal indicating a correlation between a reference signal corresponding to the second transmission signal and the reception signal.

3. The object detection apparatus according to claim 2, wherein
the first transmission signal and the second transmission signal are set such that parts of frequency bands thereof overlap with each other, but remaining parts do not.

4. The object detection apparatus according to claim 1, further comprising an amplitude signal generator configured to transform the reception signal to an amplitude signal, wherein
the signal determiner is configured to perform the signal determination by comparing the plurality of the correlation signals in a code determination range that is a time range set based on the amplitude signal.

5. The object detection apparatus according to claim 4, wherein
the signal determiner is configured to set the code determination range based on a change rate of the amplitude signal at a point at which the amplitude signal has, after a rise thereof, reached a prescribed amplitude threshold.

6. The object detection apparatus according to claim 4, wherein
different values are used for the amplitude threshold that is a threshold for determination of the amplitude signal, and a correlation threshold that is a threshold for determination of the correlation signals.

7. The object detection apparatus according to claim 4, wherein
the amplitude signal generator is configured to generate the amplitude signal based on a signal obtained by filtering the reception signal through a first filter,
the correlation signal generator is configured to generate the correlation signals based on a signal obtained by filtering the reception signal through a second filter, and
the first filter and the second filter have different values Q.

8. The object detection apparatus according to claim 4, wherein
the signal determiner is configured to set a time width of the code determination range based on a signal length of the transmission signal.

9. The object detection apparatus according to claim 1, wherein
the signal determiner is configured to perform the signal determination based on a normalized correlation signal obtained by eliminating, from the correlation signal, an influence of amplitude of the reception signal.

10. The object detection apparatus according to claim 1, wherein
the signal determiner is configured to perform the signal determination after correcting at least a delay generated in filtering and correlation calculation used for generating the correlation signal used for the signal determination.

11. The object detection apparatus according to claim 1, wherein
the transmission signal is a linear chirp signal.

12. The object detection apparatus according to claim 1, wherein
the reference signal is set to have a narrower frequency band than a frequency band of the transmission signal.
